(19) United States
(12) Patent Application Publication
(10) Pub. No.: US 2005/0088427 A1
(43) Pub. Date: Apr. 28, 2005

(54) Transferring pen information between unmanaged and managed code

(75) Inventors: Alexander J. Kolmykov-Zotov, Sammamish, WA (US); Shiraz Somji, Kenmore, WA (US); Rudolph Balaz, Redmond, WA (US)

Correspondence Address: BANNER & WITCOFF LTD.,;ATTORNEYS FOR MICROSOFT, 1001 G STREET , N.W., ELEVENTH STREET, WASHINGTON, DC, 20001-4597, US

(73) Assignee: Microsoft Corporation, Redmond, WA (US)

(21) Appl. No.: 10/692,004

(22) Filed: Oct. 24, 2003

(51) Int. Cl. G09G 1/00; G09G 3/28; G09G 3/22; G09G 5/00

(52) U.S. Cl. 345/180; 345/182; 345/183; 345/179

(57) ABSTRACT

A system and process for transferring pen data between unmanaged and managed code is described. The system uses shared memory between an unmanaged component and a managed application to store information relating to ink information. A pointer is transferred to the managed component, thereby allowing the managed component to read the information in the shared memory.

### BACKGROUND OF THE INVENTION

1. Field of the Invention

Aspects of the present invention relate to information capturing and rendering. More specifically, aspects of the present invention relate to providing an architecture for editing electronic ink.

2. Description of Related Art

People often rely on graphical representations more than textual representations of information. They would rather look at a picture than a block of text that may be equivalent to the picture. For instance, a home owner may cut out pictures from magazines to show contractors exactly what is desired when remodeling a kitchen or bathroom. Textual descriptions of the same material often fall short. The tool that the home owner may use is no more complex than a pair of scissors.

In the computing world, however, attempting to capture and convey the identical content is cumbersome. Typical computer systems do not provide an easy interface for capturing and conveying graphically intensive content. Rather, they are optimized for capturing and rendering text. For instance, typical computer systems, especially computer systems using graphical user interface (GUI) systems, such as Microsoft WINDOWS, are optimized for accepting user input from one or more discrete input devices such as a keyboard for entering text, and a pointing device such as a mouse with one or more buttons for driving the user interface.

Some computing systems have expanded the input and interaction systems available to a user by allowing the use of a stylus to input information into the systems. The stylus may take the place of both the keyboard (for data entry) as well as the mouse (for control). Some computing systems receive handwritten electronic information or electronic ink and immediately attempt to convert the electronic ink into text. Other systems permit the electronic ink to remain in the handwritten form.

Despite the existence of a stylus, various approaches to combining electronic ink with a typical graphical user interface may be cumbersome for developers of third party applications. One issue that exists is the transfer of data from unmanaged applications or components to managed applications or components.

Managed applications (relating to Microsoft Corporation's NET framework) that are receptive to stylus or pen input may require unmanaged applications to handle the initial information from the pen. The information from the pen may include information about x, y point of where the stylus is hovering over or touching a digitizer, pressure information (if the stylus is in contact with the digitizer), the angle of the stylus, state of buttons on the stylus, the identify of the stylus (or tip of the stylus), and the like. Herein, this information is referred to as “stylus packets”. To ensure high quality of ink collected using stylus, and in particular to ensure good handwriting recognition results, stylus packets are transmitted to the application (unmanaged or managed) with frequency that is as high as possible (usually limited by frequency of digitizer). The most common frequency currently is 133 packets per second, or one packet transferred approximately every 7.5 ms.

A conventional channel of communication between a digitizer and managed application is shown in FIG. 3. Here, information from a digitizer is handled by pen device drivers 301. The handled information is passed to a component 302 which may include pen services for grouping and transferring information from the digitizer to various applications. One may use NET's common language runtime (CLR) interop scheme to transfer information from the component 302 to a managed application 307. In CLR interop, a native or unmanaged component 302 exposes a COM object 303 with an interface and a type library. The type library is then imported into managed space using a type library importer (for instance, tlbimp.exe). Alternatively, one may import the stylus packets manually. Once the object has been imported, a runtime callable wrapper exists 305 which includes the interfaces for the managed applications. The runtime callable wrapper 305 may be invoked to retrieve information from the native component 302. In this scheme, every call from managed space to the native component passes through standard interop data marshalling (data transfer) as established by the runtime callable wrapper 305. Standard marshalling is generic and is able to handle wide variety of scenarios.

Frequencies of packets from the digitizer are expected to increase (thereby increasing the resolution of electronic ink). With this and higher frequencies, the pathway between the unmanaged and managed code should be streamlined to permit efficient exchange of information. The above-described pathway should be improved to handle higher frequency recurring information (for instance, stylus packets).

In general terms, FIG. 3 can be described as receiving pen data, storing the information in memory, using a mapping or translator to convert the pen data into a form expected by the managed component or application, storing the converted pen data, and alerting the managed component or application that the converted pen data exists. This final step may or may not include an indication where the new pen data is found.

If this rate of data capture is to be increased (to provide more data points, for instance), then the throughput of the data transfer from unmanaged to managed code needs to be increased.

### BRIEF SUMMARY

Aspects of the present invention solve one or more problems described above, thereby providing improved pen data transfer from unmanaged components or applications to managed components or applications. Aspects of the present invention permit shared memory access of the pen data, thereby minimizing conversion or translation of the pen data.

These and other aspects are addressed in relation to the Figures and related description.

### BRIEF DESCRIPTION OF THE DRAWINGS

The present invention is illustrated by way of example and not limited in the accompanying figures in which like reference numerals indicate similar elements and in which:

FIGS. 1A through 1M shows a general-purpose computer supporting one or more aspects of the present invention including modification of interfaces.

FIG. 2 shows a display for a stylus-based input system according to aspects of the present invention.

FIG. 3 shows a conventional approach to transferring information across an unmanaged/managed boundary.

FIG. 4 shows a process for efficient pack transfer in accordance with embodiments of the present invention.

FIG. 5 shows an illustration of packet flow using a shared memory in accordance with embodiments of the present invention.

### DETAILED DESCRIPTION OF THE DRAWINGS

Aspects of the present invention relate to an improved process for efficient ink packet transfer across an unmanaged-managed code boundary.

This document is divided into sections to assist the reader. These sections include: characteristics of ink; terms; general-purpose computing environment; shared memory between unmanaged/managed environments; and protocol.

Characteristics of Ink

As known to users who use ink pens, physical ink (the kind laid down on paper using a pen with an ink reservoir) may convey more information than a series of coordinates connected by line segments. For example, physical ink can reflect pen pressure (by the thickness of the ink), pen angle (by the shape of the line or curve segments and the behavior of the ink around discreet points), and the speed of the nib of the pen (by the straightness, line width, and line width changes over the course of a line or curve). Because of these additional properties, emotion, personality, emphasis and so forth can be more instantaneously conveyed than with uniform line width between points.

Electronic ink (or ink) relates to the capture and display of electronic information captured when a user uses a stylus-based input device. Electronic ink refers to a sequence of strokes, where each stroke is comprised of a sequence of points. The points may be represented using a variety of known techniques including Cartesian coordinates (X, Y), polar coordinates (r, Θ), and other techniques as known in the art. Electronic ink may include representations of properties of real ink including pressure, angle, speed, color, stylus size, and ink opacity. Electronic ink may further include other properties including the order of how ink was deposited on a page (a raster pattern of left to right then down for most western languages), a timestamp (indicating when the ink was deposited), indication of the author of the ink, and the originating device (at least one of an identification of a machine upon which the ink was drawn or an identification of the pen used to deposit the ink), among other information.

Terms

Ink—A sequence or set of strokes with properties. A sequence of strokes may include strokes in an ordered form. The sequence may be ordered by the time captured or by where the strokes appear on a page or in collaborative situations by the author of the ink. Other orders are possible. A set of strokes may include sequences of strokes or unordered strokes or any combination thereof. Further, some properties may be unique to each stroke or point in the stroke (for example, pressure, speed, angle, and the like). These properties may be stored at the stroke or point level, and not at the ink level.

Ink object—A data structure storing ink with or without properties.

Stroke—A sequence or set of captured points. For example, when rendered, the sequence of points may be connected with lines. Alternatively, the stroke may be represented as a point and a vector in the direction of the next point. In short, a stroke is intended to encompass any representation of points or segments relating to ink, irrespective of the underlying representation of points and/or what connects the points.

Point—Information defining a location in space. For example, the points may be defined relative to a capturing space (for example, points on a digitizer), a virtual ink space (the coordinates in a space into which captured ink is placed), and/or display space (the points or pixels of a display device).

General-Purpose Computing Environment

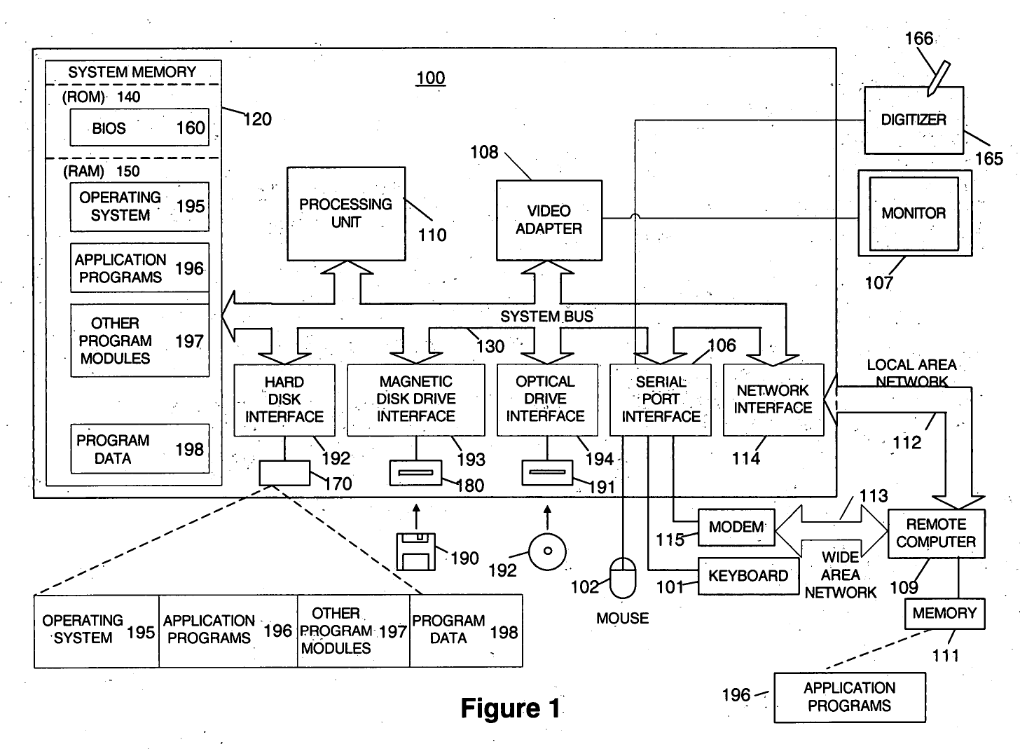

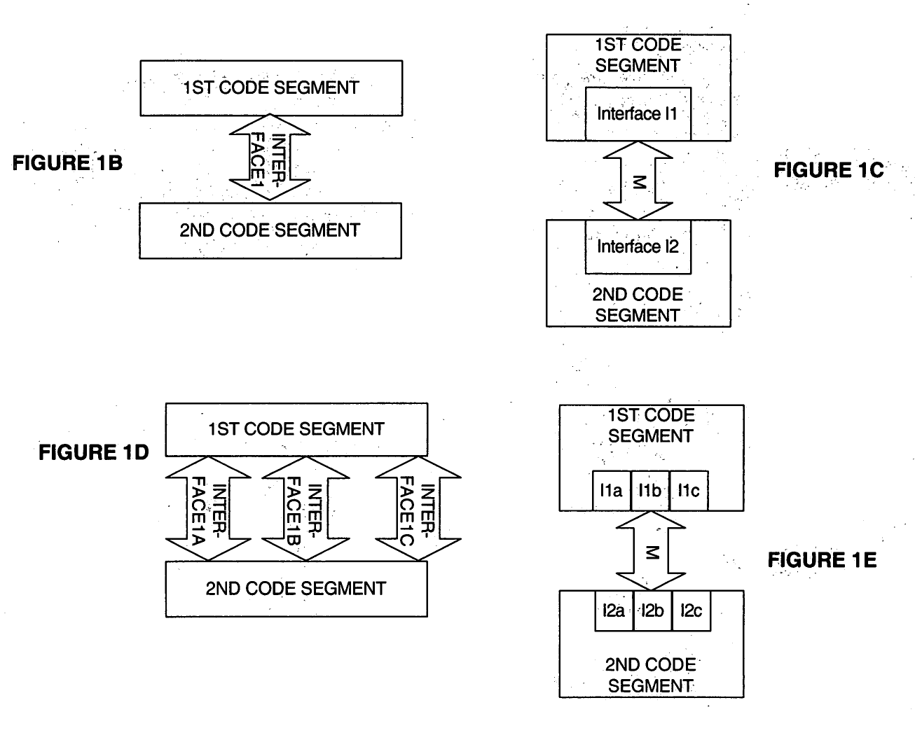

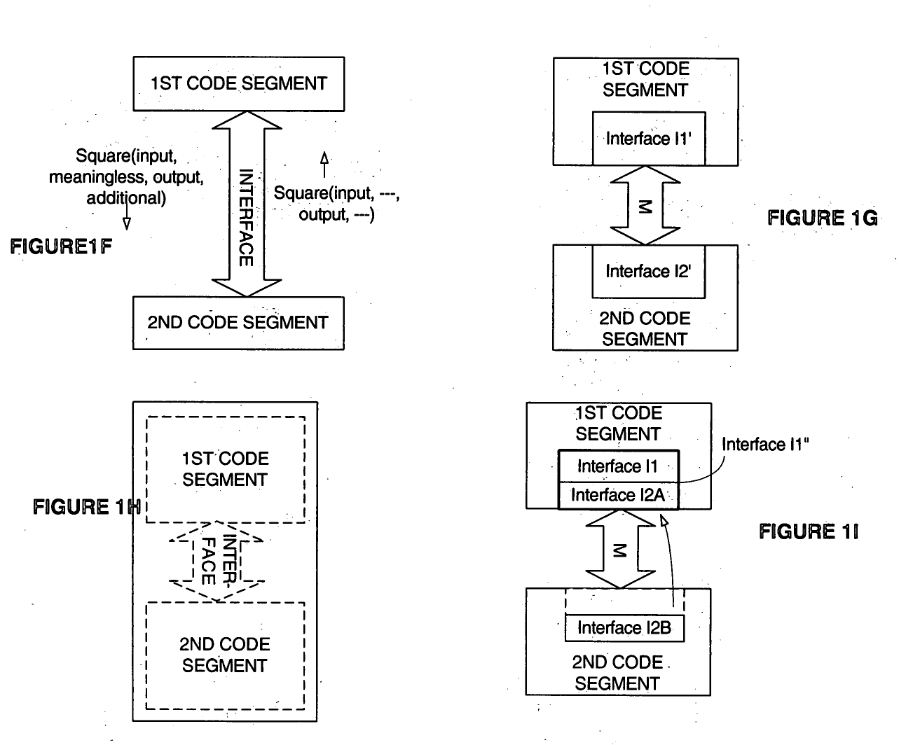

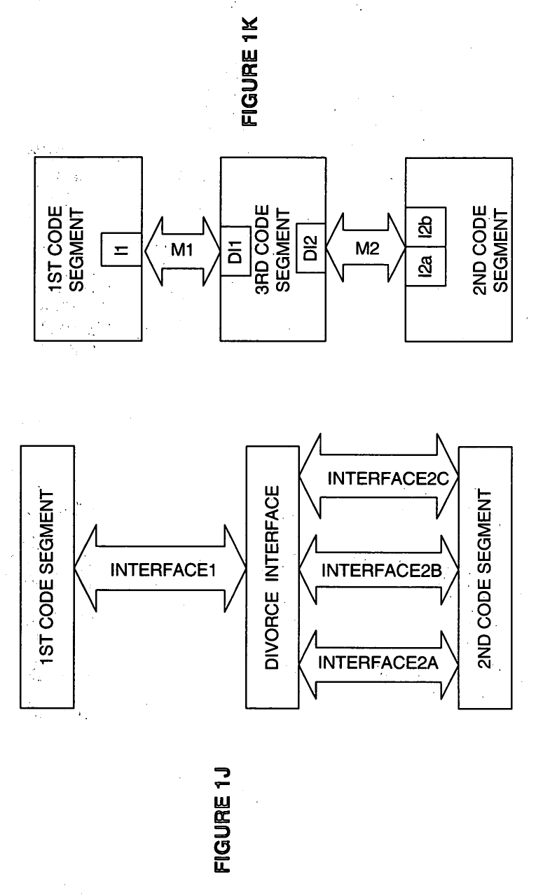

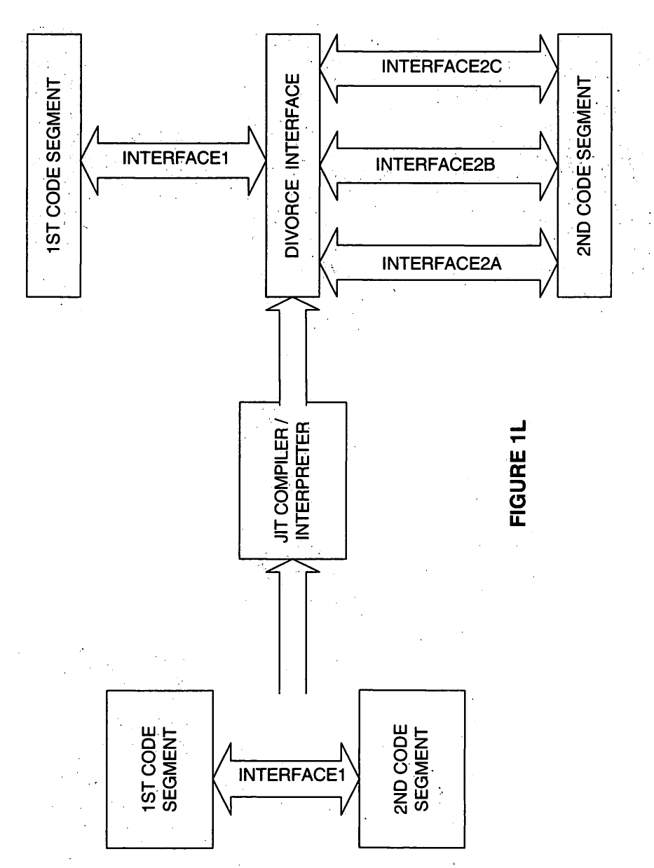

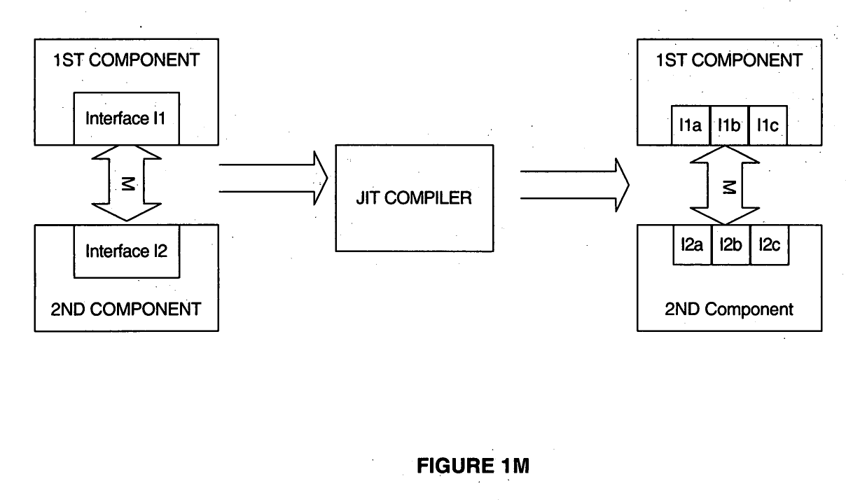

FIG. 1 illustrates a schematic diagram of an illustrative conventional general-purpose digital computing environment that can be used to implement various aspects of the present invention. In FIG. 1, a computer 100 includes a processing unit 110, a system memory 120, and a system bus 130 that couples various system components including the system memory to the processing unit 110. The system bus 130 may be any of several types of bus structures including a memory bus or memory controller, a peripheral bus, and a local bus using any of a variety of bus architectures. The system memory 120 includes read only memory (ROM) 140 and random access memory (RAM) 150.

A basic input/output system 160 (BIOS), containing the basic routines that help to transfer information between elements within the computer 100, such as during start-up, is stored in the ROM 140. The computer 100 also includes a hard disk drive 170 for reading from and writing to a hard disk (not shown), a magnetic disk drive 180 for reading from or writing to a removable magnetic disk 190, and an optical disk drive 191 for reading from or writing to a removable optical disk 192 such as a CD ROM or other optical media. The hard disk drive 170, magnetic disk drive 180, and optical disk drive 191 are connected to the system bus 130 by a hard disk drive interface 192, a magnetic disk drive interface 193, and an optical disk drive interface 194, respectively. The drives and their associated computer-readable media provide nonvolatile storage of computer readable instructions, data structures, program modules and other data for the personal computer 100. It will be appreciated by those skilled in the art that other types of computer readable media that can store data that is accessible by a computer, such as magnetic cassettes, flash memory cards, digital video disks, Bernoulli cartridges, random access memories (RAMs), read only memories (ROMs), and the like, may also be used in the example operating environment.

A number of program modules can be stored on the hard disk drive 170, magnetic disk 190, optical disk 192, ROM 140 or RAM 150, including an operating system 195, one or more application programs 196, other program modules 197, and program data 198. A user can enter commands and information into the computer 100 through input devices such as a keyboard 101 and pointing device 102. Other input devices (not shown) may include a microphone, joystick, game pad, satellite dish, scanner or the like. These and other input devices are often connected to the processing unit 110 through a serial port interface 106 that is coupled to the system bus, but may be connected by other interfaces, such as a parallel port, game port or a universal serial bus (USB). Further still, these devices may be coupled directly to the system bus 130 via an appropriate interface (not shown). A monitor 107 or other type of display device is also connected to the system bus 130 via an interface, such as a video adapter 108. In addition to the monitor, personal computers typically include other peripheral output devices (not shown), such as speakers and printers. In one embodiment, a pen digitizer 165 and accompanying pen or stylus 166 are provided in order to digitally capture freehand input. Although a direct connection between the pen digitizer 165 and the serial port interface 106 is shown, in practice, the pen digitizer 165 may be coupled to the processing unit 110 directly, parallel port or other interface and the system bus 130 by any technique including wirelessly. Also, the pen 166 may have a camera associated with it and a transceiver for wirelessly transmitting image information captured by the camera to an interface interacting with bus 130. Further, the pen may have other sensing systems in addition to or in place of the camera for determining strokes of electronic ink including accelerometers, magnetometers, and gyroscopes.

Furthermore, although the digitizer 165 is shown apart from the monitor 107, the usable input area of the digitizer 165 may be co-extensive with the display area of the monitor 107. Further still, the digitizer 165 may be integrated in the monitor 107, or may exist as a separate device overlaying or otherwise appended to the monitor 107.

The computer 100 can operate in a networked environment using logical connections to one or more remote computers, such as a remote computer 109. The remote computer 109 can be a server, a router, a network PC, a peer device or other common network node, and typically includes many or all of the elements described above relative to the computer 100, although only a memory storage device 111 has been illustrated in FIG. 1. The logical connections depicted in FIG. 1 include a local area network (LAN) 112 and a wide area network (WAN) 113. Such networking environments are commonplace in offices, enterprise-wide computer networks, intranets and the Internet.

When used in a LAN networking environment, the computer 100 is connected to the local network 112 through a network interface or adapter 114. When used in a WAN networking environment, the personal computer 100 typically includes a modem 115 or other means for establishing a communications over the wide area network 113, such as the Internet. The modem 115, which may be internal or external, is connected to the system bus 130 via the serial port interface 106. In a networked environment, program modules depicted relative to the personal computer 100, or portions thereof, may be stored in the remote memory storage device. Further, the system may include wired and/or wireless capabilities. For example, network interface 114 may include Bluetooth, SWLan, and/or IEEE 802.11 class of combination abilities. It is appreciated that other wireless communication protocols may be used in conjunction with these protocols or in place of these protocols.

It will be appreciated that the network connections shown are illustrative and other techniques for establishing a communications link between the computers can be used.

The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

A programming interface (or more simply, interface) may be viewed as any mechanism, process, protocol for enabling one or more segment(s) of code to communicate with or access the functionality provided by one or more other segment(s) of code. Alternatively, a programming interface may be viewed as one or more mechanism(s), method(s), function call(s), module(s), object(s), etc. of a component of a system capable of communicative coupling to one or more mechanism(s), method(s), function call(s), module(s), etc. of other component(s). The term “segment of code” in the preceding sentence is intended to include one or more instructions or lines of code, and includes, e.g., code modules, objects, subroutines, functions, and so on, regardless of the terminology applied or whether the code segments are separately compiled, or whether the code segments are provided as source, intermediate, or object code, whether the code segments are utilized in a runtime system or process, or whether they are located on the same or different machines or distributed across multiple machines, or whether the functionality represented by the segments of code are implemented wholly in software, wholly in hardware, or a combination of hardware and software.

Notionally, a programming interface may be viewed generically, as shown in FIG. 1B or FIG. 1C. FIG. 1B illustrates an interface Interface1 as a conduit through which first and second code segments communicate. FIG. 1C illustrates an interface as comprising interface objects I1 and I2 (which may or may not be part of the first and second code segments), which enable first and second code segments of a system to communicate via medium M. In the view of FIG. 1C, one may consider interface objects I1 and I2 as separate interfaces of the same system and one may also consider that objects I1 and I2 plus medium M comprise the interface. Although FIGS. 1B and 1C show bi-directional flow and interfaces on each side of the flow, certain implementations may only have information flow in one direction (or no information flow as described below) or may only have an interface object on one side. By way of example, and not limitation, terms such as application programming interface (API), entry point, method, function, subroutine, remote procedure call, and component object model (COM) interface, are encompassed within the definition of programming interface.

Aspects of such a programming interface may include the method whereby the first code segment transmits information (where “information” is used in its broadest sense and includes data, commands, requests, etc.) to the second code segment; the method whereby the second code segment receives the information; and the structure, sequence, syntax, organization, schema, timing and content of the information. In this regard, the underlying transport medium itself may be unimportant to the operation of the interface, whether the medium be wired or wireless, or a combination of both, as long as the information is transported in the manner defined by the interface. In certain situations, information may not be passed in one or both directions in the conventional sense, as the information transfer may be either via another mechanism (e.g. information placed in a buffer, file, etc. separate from information flow between the code segments) or non-existent, as when one code segment simply accesses functionality performed by a second code segment. Any or all of these aspects may be important in a given situation, e.g., depending on whether the code segments are part of a system in a loosely coupled or tightly coupled configuration, and so this list should be considered illustrative and non-limiting.

This notion of a programming interface is known to those skilled in the art and is clear from the foregoing detailed description of the invention. There are, however, other ways to implement a programming interface, and, unless expressly excluded, these too are intended to be encompassed by the claims set forth at the end of this specification. Such other ways may appear to be more sophisticated or complex than the simplistic view of FIGS. 1B and 1C, but they nonetheless perform a similar function to accomplish the same overall result. We will now briefly describe some illustrative alternative implementations of a programming interface.

### A. Factoring

A communication from one code segment to another may be accomplished indirectly by breaking the communication into multiple discrete communications. This is depicted schematically in FIGS. 1D and 1E. As shown, some interfaces can be described in terms of divisible sets of functionality. Thus, the interface functionality of FIGS. 1B and 1C may be factored to achieve the same result, just as one may mathematically provide 24, or 2 times 2 times 3 times 2. Accordingly, as illustrated in FIG. 1D, the function provided by interface Interface 1 may be subdivided to convert the communications of the interface into multiple interfaces Interface 1A, Interface 1B, Interface 1C, etc. while achieving the same result. As illustrated in FIG. 1E, the function provided by interface I1 may be subdivided into multiple interfaces I1a, I1b, I1c, etc. while achieving the same result. Similarly, interface I2 of the second code segment which receives information from the first code segment may be factored into multiple interfaces I2a, I2b, I2c, etc. When factoring, the number of interfaces included with the 1st code segment need not match the number of interfaces included with the 2nd code segment. In either of the cases of FIGS. 1D and 1E, the functional spirit of interfaces Interface1 and I1 remain the same as with FIGS. 1B and 1C, respectively. The factoring of interfaces may also follow associative, commutative, and other mathematical properties such that the factoring may be difficult to recognize. For instance, ordering of operations may be unimportant, and consequently, a function carried out by an interface may be carried out well in advance of reaching the interface, by another piece of code or interface, or performed by a separate component of the system. Moreover, one of ordinary skill in the programming arts can appreciate that there are a variety of ways of making different function calls that achieve the same result.

### B. Redefinition

In some cases, it may be possible to ignore, add or redefine certain aspects (e.g., parameters) of a programming interface while still accomplishing the intended result. This is illustrated in FIGS. 1F and 1G. For example, assume interface Interface1 of FIG. 1B includes a function call Square (input, precision, output), a call that includes three parameters, input, precision and output, and which is issued from the 1st Code Segment to the 2nd Code Segment. If the middle parameter precision is of no concern in a given scenario, as shown in FIG. 1F, it could just as well be ignored or even replaced with a meaningless (in this situation) parameter. One may also add an additional parameter of no concern. In either event, the functionality of square can be achieved, so long as output is returned after input is squared by the second code segment. Precision may very well be a meaningful parameter to some downstream or other portion of the computing system; however, once it is recognized that precision is not necessary for the narrow purpose of calculating the square, it may be replaced or ignored. For example, instead of passing a valid precision value, a meaningless value such as a birth date could be passed without adversely affecting the result. Similarly, as shown in FIG. 1G, interface I1 is replaced by interface I1′, redefined to ignore or add parameters to the interface. Interface I2 may similarly be redefined as interface I2′, redefined to ignore unnecessary parameters, or parameters that may be processed elsewhere. The point here is that in some cases a programming interface may include aspects, such as parameters, which are not needed for some purpose, and so they may be ignored or redefined, or processed elsewhere for other purposes.

### C. Inline Coding

It may also be feasible to merge some or all of the functionality of two separate code modules such that the “interface” between them changes form. For example, the functionality of FIGS. 1B and 11C may be converted to the functionality of FIGS. 1H and 1I, respectively. In FIG. 1H, the previous. 1st and 2nd Code Segments of FIG. 1B are merged into a module containing both of them. In this case, the code segments may still be communicating with each other but the interface may be adapted to a form which is more suitable to the single module. Thus, for example, formal Call and Return statements may no longer be necessary, but similar processing or response(s) pursuant to interface Interface1 may still be in effect. Similarly, shown in FIG. 1I, part (or all) of interface I2 from FIG. 1C may be written inline into interface I1 to form interface I1″.

As illustrated, interface I2 is divided into I2a and I2b, and interface portion 12a has been coded in-line with interface I1 to form interface I1″. For a concrete example, consider that the interface I1 from FIG. 1C performs a function call square (input, output), which is received by interface I2, which after processing the value passed with input (to square it) by the second code segment, passes back the squared result with output. In such a case, the processing performed by the second code segment (squaring input) can be performed by the first code segment without a call to the interface.

### D. Divorce

A communication from one code segment to another may be accomplished indirectly by breaking the communication into multiple discrete communications. This is depicted schematically in FIGS. 1J and 1K. As shown in FIG. 1J, one or more piece(s) of middleware (Divorce Interface(s), since they divorce functionality and/or interface functions from the original interface) are provided to convert the communications on the first interface, Interface1, to conform them to a different interface, in this case interfaces Interface2A, Interface2B and Interface2C. This might be done, e.g., where there is an installed base of applications designed to communicate with, say, an operating system in accordance with an Interface1 protocol, but then the operating system is changed to use a different interface, in this case interfaces Interface2A, Interface2B and Interface2C. The point is that the original interface used by the 2nd Code Segment is changed such that it is no longer compatible with the interface used by the 1st Code Segment, and so an intermediary is used to make the old and new interfaces compatible. Similarly, as shown in FIG. 1K, a third code segment can be introduced with divorce interface DI1 to receive the communications from interface I1 and with divorce interface DI2 to transmit the interface functionality to, for example, interfaces 12a and 12b, redesigned to work with DI2, but to provide the same functional result. Similarly, DI1″ and DI2 may work together to translate the functionality of interfaces I1 and I2 of FIG. 1C to a new operating system, while providing the same or similar functional result.

### E. Rewriting

Yet another possible variant is to dynamically rewrite the code to replace the interface functionality with something else but which achieves the same overall result. For example, there may be a system in which a code segment presented in an intermediate language (e.g. Microsoft IL, Java ByteCode, etc.) is provided to a Just-in-Time (JIT) compiler or interpreter in an execution environment (such as that provided by the Net framework, the Java runtime environment, or other similar runtime type environments). The JIT compiler may be written so as to dynamically convert the communications from the 1st Code Segment to the 2nd Code Segment, i.e., to conform them to a different interface as may be required by the 2nd Code Segment (either the original or a different 2nd Code Segment). This is depicted in FIGS. 1L and 1M. As can be seen in FIG. 1L, this approach is similar to the Divorce scenario described above. It might be done, e.g., where an installed base of applications are designed to communicate with an operating system in accordance with an Interface 1 protocol, but then the operating system is changed to use a different interface. The JIT Compiler could be used to conform the communications on the fly from the installed-base applications to the new interface of the operating system. As depicted in FIG. 1M, this approach of dynamically rewriting the interface(s) may be applied to dynamically factor, or otherwise alter the interface(s) as well.

It is also noted that the above-described scenarios for achieving the same or similar result as an interface via alternative embodiments may also be combined in various ways, serially and/or in parallel, or with other intervening code. Thus, the alternative embodiments presented above are not mutually exclusive and may be mixed, matched and combined to produce the same or equivalent scenarios to the generic scenarios presented in FIGS. 1B and 1C. It is also noted that, as with most programming constructs, there are other similar ways of achieving the same or similar functionality of an interface which may not be described herein, but nonetheless are represented by the spirit and scope of the invention, i.e., it is noted that it is at least partly the functionality represented by, and the advantageous results enabled by, an interface that underlie the value of an interface.

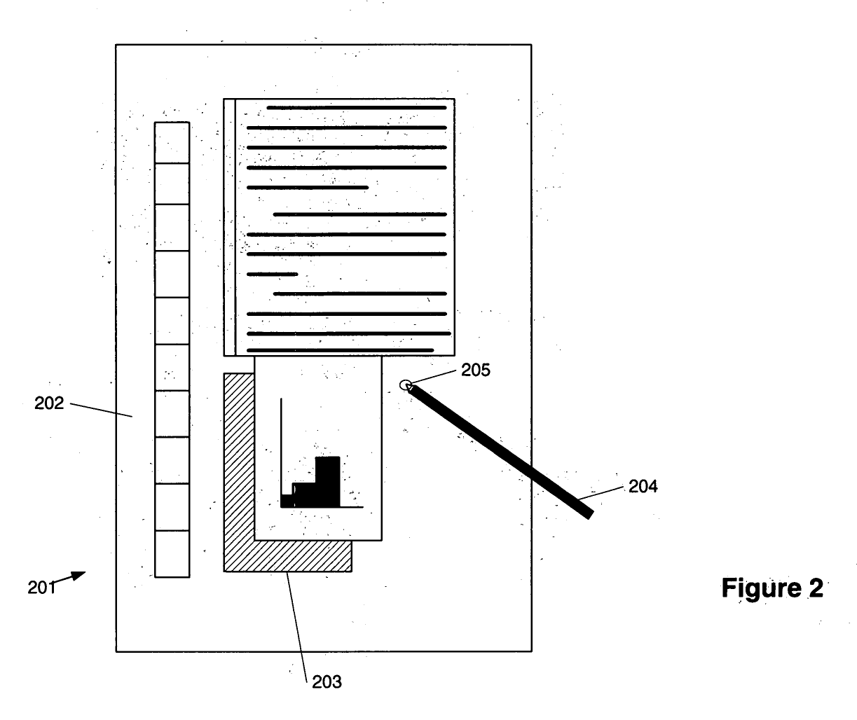

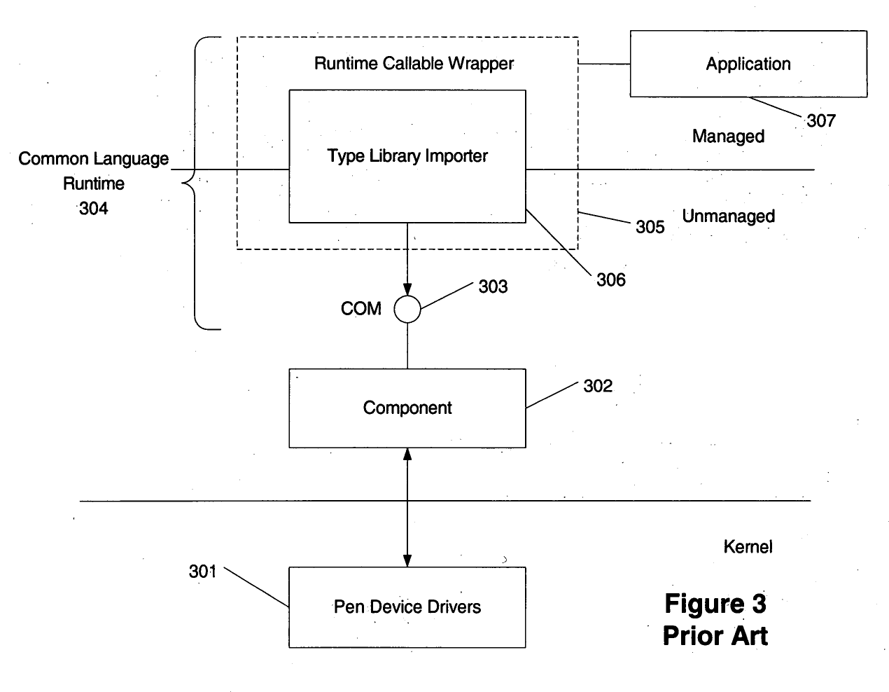

FIG. 2 illustrates an illustrative tablet PC 201 that can be used in accordance with various aspects of the present invention. Any or all of the features, subsystems, and functions in the system of FIG. 1 can be included in the computer of FIG. 2. Tablet PC 201 includes a large display surface 202, e.g., a digitizing flat panel display, preferably, a liquid crystal display (LCD) screen, on which a plurality of windows 203 is displayed. Using stylus 204, a user can select, highlight, and/or write on the digitizing display surface 202. Examples of suitable digitizing display surfaces 202 include electromagnetic pen digitizers, such as Mutoh or Wacom pen digitizers. Other types of pen digitizers, e.g., optical digitizers, may also be used. Tablet PC 201 interprets gestures made using stylus 204 in order to manipulate data, enter text, create drawings, and/or execute conventional computer application tasks such as spreadsheets, word processing programs, and the like.

The stylus 204 may be equipped with one or more buttons or other features to augment its selection capabilities. In one embodiment, the stylus 204 could be implemented as a “pencil” or “pen”, in which one end constitutes a writing portion and the other end constitutes an “eraser” end, and which, when moved across the display, indicates portions of the display are to be erased. Other types of input devices, such as a mouse, trackball, or the like could be used. Additionally, a user's own finger could be the stylus 204 and used for selecting or indicating portions of the displayed image on a touch-sensitive or proximity-sensitive display. Consequently, the term “user input device”, as used herein, is intended to have a broad definition and encompasses many variations on well-known input devices such as stylus 204. Region 205 shows a feedback region or contact region permitting the user to determine where the stylus 204 as contacted the display surface 202.

In various embodiments, the system provides an ink platform as a set of COM (component object model) services that an application can use to capture, manipulate, and store ink. One service enables an application to read and write ink using the disclosed representations of ink. The ink platform may also include a mark-up language including a language like the extensible markup language (XML). Further, the system may use DCOM as another implementation. Yet further implementations may be used including the Win32 programming model and the .Net programming model from Microsoft Corporation.

Shared Memory Between Unmanaged/Managed Environments

Aspects of the present invention include a communication system between unmanaged and managed code that uses shared memory, native Windows synchronization objects and P-Invoke protocols to transfer packets to a managed application. One area of application of the communication system is for the transfer of packets. Evaluations of the communication system described herein suggest that it is 2-5 times faster than the standard CLR interop scheme.

The use of a streamlined communication pathway provides for improved quality and scalability of ink in managed ink-aware applications. By having efficient and optimized channel for stylus packets transfer, process cycles are freed up for other applications including interface modifications and handwriting recognition processing.

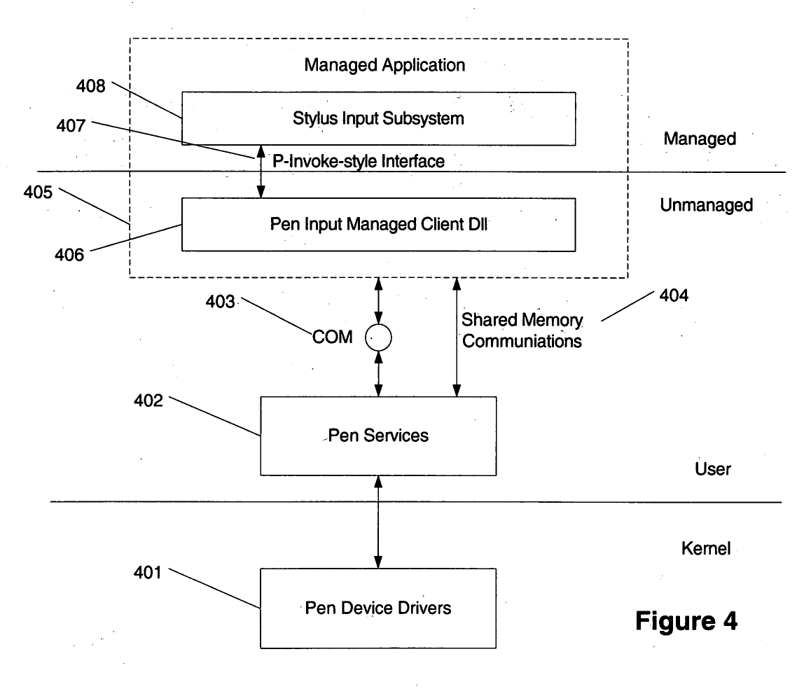

FIG. 4 shows a system using aspects of the present invention. Pen information is handled by pen device drivers 401 and transferred to pen services component 402. Pen services component 402 is an unmanaged (or native) component that communicates with digitizers on the system. For instance, WISPTIS as known in the art may be used as pen services 402. Pen services 402 establish a shared memory pathway 404 between itself and managed application 405. Stylus packets may be transferred through the shared memory pathway 404.

An example of the stylus packets that may be exchanged is as follows: stylus_packet(x,y,pressure,angle,tipID,contact). This is but one illustration of stylus packets. The x,y data may relate to the location on the digitizer of the cursor or pen tip.

The x,y data may be raw data from the digitizer or may be mapped or normalized information. The pressure and angle are the pressure and angle of the pen. The tip ID is the identification of the pen tip (or which stylus) is being used. Contact is whether the x,y coordinates relate to a pen tip being in contact with a digitizer or in the air. It is appreciated that the tip id and contact may be omitted and found in other pathways or taken into account by the system in other ways. Contact may be not be used with non-active pens (ones that function based only on contact with a digitizer).

A stylus packet may be generated for each new data point from the digitizer.

Alternatively, points may be grouped together to minimize the number of status packets crossing the managed-unmanaged boundary. For instance, one may send 5, 10, or any number of x,y coordinates denoting pen movement or location to minimize the total number of packets passing through shared memory communications 404.

An unmanaged component, pen input managed client 406 may be used to connect to pen services 402. The pen input managed client 406 may be part of managed application 405.

The pen input managed client 406 accesses the shared memory window and interfaces with protocol from pen services 402. Pen input managed client exposes a P-Invoke interface 407 to cross the unmanaged-managed boundary. Access points associated with pen input managed client 406 through which managed application 405 may wait for information from pen services 402 and may gain access to a pointer to the shared memory window segment that contains the packet data.

At least some of the packet information may be stored in the shared memory as an array of integers. Other formats may be used. One advantage of integers is they allow for efficient marshalling of packet information into the managed storage.

Protocol

A variety of protocols may be used in the shared memory. The following provides an illustration. Others are possible.

First, when managed application 405 enables stylus input, pen input managed client d11 406 is loaded into application 405. The pen input managed client d11 may then use COM (component object model) to establish initial connection to pen service 402. Next, pen input managed client d11 406 may then create a context object for the window of the application 405. The context object may be generic to all tablets present or each object created may be specific to each tablet. This may occur by means of COM or another protocol; The shared memory may be common for all context objects or separate shared memories may be created to handle every context.

Various synchronization objects are described below. After creation of the objects, handles may be duplicated for a client process and passed into the pen input managed client d11 406. The pen input managed client d11 may store the handles in an object (for instance pen input managed client context (PIMCContext, for instance) that correspond to the pen services 402 context. The handles may then be passed to the managed side.

Next, application 405 may be executed and input received at pen services 402 regarding a user's use of a stylus. Application 405 may have a thread running whose normal state is to wait for a pen services' event that indicates that more data is available for processing.

When the event is received in application 405, the client application obtains a mutex “shared memory” object to access the shared memory window. A mutex is a mutual exclusion object. It may be a program object that allows multiple program threads to share the same resource, such as file access, but not simultaneously. When a program is started, a mutex is created with a unique name. After this stage, any thread that needs the resource can lock the mutex from other threads while it is using the resource. The mutex is set to unlock when the data is no longer needed or the routine is finished.

The application then retrieves data from the shared memory window, releases mutex, and signals back to pen service with an event that the client is ready. One example of this process may be performed using the P-Invoke method “GetData” as called from the managed stylus input subsystem 408.

The following provides an example of a single window and a single tablet. The packets retrieval loop may be constriucted as follows:

while (GetData(handleOfPimcContext))
{

... process data

}

There may be more than one context in the managed application 405. This scenario may be handed with a more generic version of the GetData method that takes into account the pen input managed client's contexts. The data loop may be constructed as follows:

while (GetDataMultiple(arrayOfHandlesOfPimcContexts))
{

... process data

}

Contexts may be created and destroyed dynamically during a lifetime of the application. The actual loop and multiple. GetData methods (for instance GetDataMultiple) may include logic for breaking the application 405's waiting in order to update array handles from the pen input managed client contexts. The data loop may be constructed as follows:

while (GetDataMultiple(arrayOfHandlesOfPimcContexts, eventBreak))
{

... process data

}

Here, “eventBreak” is an event signaled from the managed code when one or more contexts need to be added or removed from the wait.

Once GetData or GetDataMultiple returns data, pointers to shared memory window segments that contain relevant data may return to the managed side of application 408. Before forming an actual stylus input report and event for the data returned, a memory may be used in marshalling code to efficiently unpack and transfer the data into memory allocated in the managed heap.

Here, pen data received from pen service 402 may be transformed into a data structure/class identified as StylusInputReport. This class may be derived from an InputReport class. An event “InputReport” is raised for every input report created in the system. The input report then subsequently gets promoted into series of derived events. For example, stylus coming in contact with digitizer may result in:
1) A StylusInputReport that contains an action property or event set to RawStylusAction.StylusDown;
2) A PreviewStylusDown event; and/or
3) StylusDownEvent.

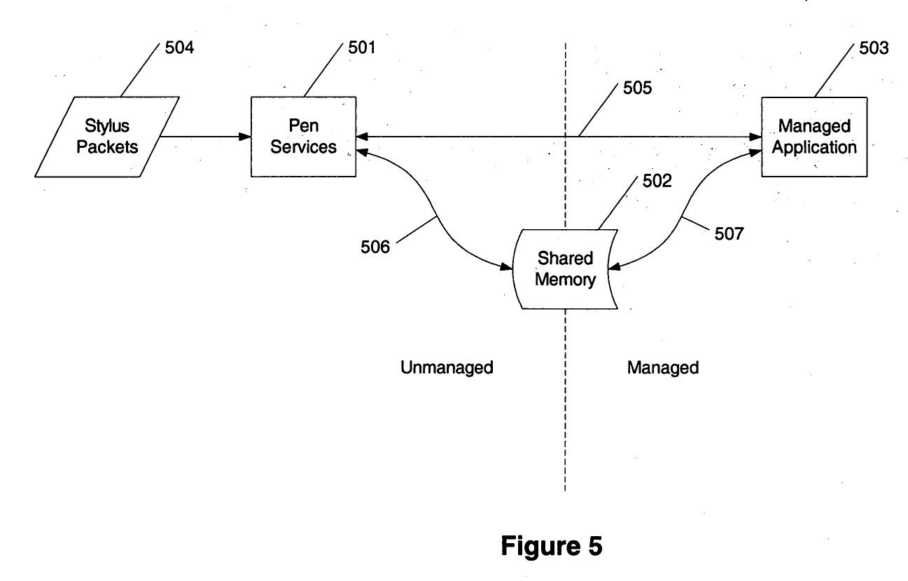

FIG. 5 shows an example how pointers may be exchanged to reference a shared memory. Stylus packets 504 are sent to pen services component 501. Pen services component 501 forwards the packets (or information related to stylus packets 504, for instance, only x,y data or x,y data and contact information, etc.) to shared memory 502 as shown by arrow 506. A pointer (or copy of pointer) referencing the location of the stylus packet 504 (or information related to stylus packets 504) is sent to managed application 503. The managed application 503 may retrieve the stylus packet 504 by accessing it with pointer 507. Arrows 505, 506, and 507 are shown as bidirectional as the shared memory may be used to transfer information into managed space and out of managed space.

Aspects of the present invention have been described in terms of illustrative embodiments thereof. Numerous other embodiments, modifications and variations within the scope and spirit of the appended claims will occur to persons of ordinary skill in the art from a review of this disclosure.

1. A process for transferring pen data between unmanaged and managed code comprising the step of:
receiving pen data in a component written in unmanaged code;
transferring information related to said pen data to a shared memory;
transferring a pointer that points to said information in said shared memory to an application written at least in part in managed code; and
retrieving said information from said shared memory.

2. The process according to claim 1, further comprising the steps of:
transferring additional information from said at least in part managed application to said shared memory;
transferring a pointer that points to said additional information to said component;
retrieving said additional information from said shared memory.

3. The process according to claim 1, further comprising the step of:
using a P-invoke style interface crossing between unmanaged code and managed code.

4. The process according to claim 1, further comprising the step of:
exchanging information through a COM interface.

5. The process according to claim 1, said component being a pen services component.

6. The process according to claim 1, said application including a pen input managed client.

7. The process according to claim 1, said component receiving input from at least one pen device driver.

8. A system for transferring information between unmanaged code and managed code comprising:
a shared memory
a component that receives pen data and transfers information relating to said pen data to said shared memory and transfers a pointer that points to said information to an application having managed code;
said application having managed code receives said pointer and obtains said information from said shared memory.

9. The system according to claim 8, said component exposing a COM interface.

10. The system according to claim 8, said application using a P-Invoke-style command.

11. The system according to claim 8, said component including a pen services component.

12. The system according to claim 8, further comprising:
at least one pen device driver sending information to said component.

13. The system according to claim 8, further comprising:
said application including a pen input managed client.

14. A computer-readable medium having a program stored thereon for transferring information related to ink between an unmanaged component and an application including managed code, said program comprising the steps of:
receiving pen data in a component written in unmanaged code;
transferring information related to said pen data to a shared memory;
transferring a pointer that points to said information in said shared memory to an application written at least in part in managed code; and
retrieving said information from said shared memory.

15. The computer-readable medium according to claim 14, said program further comprising the steps of:
transferring additional information from said at least in part managed application to said shared memory;
transferring a pointer that points to said additional information to said component;
retrieving said additional information from said shared memory.

16. The computer-readable medium according to claim 14, said program further comprising the step of:
using a P-invoke style interface crossing between unmanaged code and managed code.

17. The computer-readable medium according to claim 14, said program further comprising the step of:
exchanging information through a COM interface.

18. The computer-readable medium according to claim 14, said component being a pen services component.

19. The computer-readable medium according to claim 14, said application including a pen input managed client.

20. The computer-readable medium according to claim 14, said component receiving input from at least one pen device driver.
